(19) United States
(12) Patent Application Publication
(10) Pub. No.: US 2026/0220265 A1
(43) Pub. Date: Jul. 30, 2026

(54) RANSOMWARE DETECTION SYSTEM FOR NVME-OF BASED STORAGE USING THE AGGREGATION OF NVME SEQUENCES

(71) Applicant: SAMSUNG ELECTRONICS CO., LTD., Suwon-si (KR)

(72) Inventors: Amit Berman, Tel-Aviv (IL); Barak Bringoltz, Tel Aviv (IL); Evgeny Blaichman, Tel-Aviv (IL)

(73) Assignee: SAMSUNG ELECTRONICS CO., LTD., Suwon-si (KR)

(21) Appl. No.: 19/039,439

(22) Filed: Jan. 28, 2025

(51) Int. Cl. G06F 21/56; G06F 21/54

(52) U.S. Cl. CPC G06F 21/565; G06F 21/54; G06F 21/568

(57) ABSTRACT

Methods, devices, and systems for performing ransomware detection, including: obtaining a nonvolatile memory express over fabrics (NVMe-oF) command stream comprising a plurality of nonvolatile memory express (NVMe) commands associated with a storage device; pre-processing the NVMe-oF command stream to obtain a pre-processed command stream; dividing the pre-processed command stream into a plurality of chunks; obtaining an inference result by providing a chunk from among the plurality of chunks to an artificial intelligence (AI) model; and based on the inference result indicating that the chunk includes one or more malicious NVMe commands, performing a memory recovery operation associated with the storage device.

### BACKGROUND

### 1. Field

Apparatuses and methods consistent with embodiments relate to protection of storage devices, and more particularly to detecting malicious ransomware operations.

### 2. Description of Related Art

Malicious software such as malware can come in many forms. One type of malware that has become increasingly common is referred to as ransomware. Ransomware may target any type of computer system, such as personal computers, mobile devices, servers, and any other type of device. As one example, devices that are based on technologies such as nonvolatile memory express over fabrics (NVMe-oF) may have a very large volume and may be widely used by big data centers. Thus, these devices are often a desirable target for ransomware attacks.

Generally, ransomware may refer to malware which denies a user access to data stored on the user's device, and demands payment for restoration of access to the data. For example, a ransomware attack may begin with a distribution campaign which may distribute a download dropper for the malware using, for example, social engineering techniques or weaponized websites. The malicious code associated with the ransomware may then infect the user's device, for example by downloading an executable which may install the ransomware. This may be followed by malicious payload staging, in which the ransomware is established and embedded on the device, and may exhibit persistency. Then, the ransomware may scan the device to locate data targets, which may be stored locally or in network accessible resources. Then, the targeted data may be encrypted, and a ransom message may be provided to the user demanding payment and providing instructions to the user for providing the payment.

The targeted data may include, for example, all data of the device, or may include a smaller subset of the data. For example, the ransomware may target specific file extensions such as “.doc”, “.jpg”, “.pdf”, or files containing text documents, presentations, or images, or any other personal data. The targeted data may include large amounts of data, such as several gigabytes, and the encryption process may proceed quickly, for example in just a few seconds or minutes.

Many techniques for detecting, mitigating, or preventing ransomware attacks approach the problem through the operating system (OS) and therefore are limited by its privileges. A minority of methods use access NVMe series patterns of the OS to disk. These methods, however, may not utilize the sequential aspect of the series, but instead take momentary “snapshots” of a set of NVMe commands, and perform simple statistical analysis on them. Also, even if these techniques may be able to detect the presence or absence of a ransomware process, they may be unable to predict the amount of data that was read or written by the ransomware.

As a result, storage devices may be victim to malicious attacks such as ransomware attacks which lock, encrypt, or otherwise deny access to or control over data stored on the victim's storage device.

### SUMMARY

In accordance with an aspect of the disclosure, a method for performing ransomware detection is executed by at least one processor and includes: obtaining a nonvolatile memory express over fabrics (NVMe-oF) command stream comprising a plurality of nonvolatile memory express (NVMe) commands associated with a storage device; pre-processing the NVMe-oF command stream to obtain a pre-processed command stream; dividing the pre-processed command stream into a plurality of chunks; obtaining an inference result by providing a chunk from among the plurality of chunks to an artificial intelligence (AI) model; and based on the inference result indicating that the chunk includes one or more malicious NVMe commands, performing a memory recovery operation associated with the storage device.

In accordance with an aspect of the disclosure, a device for performing ransomware detection includes: an interface configured to communicate with a storage device; and at least one processor configured to: obtain nonvolatile memory express over fabrics (NVMe-oF) command stream comprising a plurality of nonvolatile memory express (NVMe) commands associated with the storage device; pre-process the NVMe-oF command stream to obtain a pre-processed command stream; divide the pre-processed command stream into a plurality of chunks; obtain an inference result by providing a chunk from among the plurality of chunks to an artificial intelligence (AI) model; and based on the inference result indicating that the chunk includes one or more malicious NVMe commands, perform a memory recovery operation associated with the storage device.

In accordance with an aspect of the disclosure, a storage system, includes: a storage device; a ransomware detection device including at least one processor configured to: obtain an NVME-oF command stream comprising a plurality of NVMe commands associated with the storage device; pre-process the NVMe-oF command stream to obtain a pre-processed command stream; divide the pre-processed command stream into a plurality of chunks; obtain an inference result by providing a chunk from among the plurality of chunks to an artificial intelligence (AI) model; an based on the inference result indicating that the chunk includes one or more malicious NVMe commands, perform a memory recovery operation associated with the storage device.

### BRIEF DESCRIPTION OF THE DRAWINGS

FIG. 1 is a block diagram of a computer system, according to embodiments.

FIG. 2 is a block diagram of a host storage system, according to embodiments.

FIG. 3 is a block diagram of a memory system, according to embodiments.

FIG. 4 is a block diagram of a memory device, according to embodiments.

FIG. 5 is a block diagram of a UFS system, according to embodiments.

FIG. 6 is a block diagram of a memory system, according to embodiments.

FIG. 7 is a block diagram of data center, according to embodiments.

FIG. 8 is a block diagram of an example of a storage system, according to embodiments, according to embodiments.

FIG. 9 is a block diagram of a logical flow of a process for ransomware defense, according to embodiments.

FIGS. 10A, 10B, and 10C illustrate examples of artificial intelligence models which may be used for detecting ransomware attacks, according to embodiments.

FIG. 11 is a flowchart of a process of controlling a storage system, according to embodiments.

### DETAILED DESCRIPTION

As discussed above, there is a need for techniques for improved detection of malicious attacks such as ransomware attacks which lock, encrypt, or otherwise deny access to or control over data stored on the victim's storage device. For example, some approaches to malware and ransomware defense are implemented at the operating system (OS) level, and are therefore able to be circumvented or attacked by some ransomware. In addition, to the extent that these approaches may use nonvolatile memory express (NVMe) data, they often ignore the temporal/sequential aspect of ransomware accesses patterns to the storage device, and instead only use features that are statistically aggregated from the underlying sequence.

Accordingly, embodiments may relate to single solution that combines an immunity to attacks by the ransomware on the defense solution itself, and the ability to measure the data which the ransomware read or wrote. Improved accuracy may be achieved by going beyond simple statistical attributes of the particular chunks of nonvolatile memory express (NVMe) data inspected, for example by also observing how the NVMe series changes within each chunk. This last property may allow embodiments to provide a complete defense solution, for example by choosing to eliminate false alarms with a comparably high threshold on the data written, or by setting special recovery rules that take as input the data read and written.

For example, embodiments may provide systems, methods, and devices which protect a storage device against cyber-attacks such as ransomware, which may involve loss or theft of data stored on the storage device. In embodiments, a protection layer may be added inside a storage device such as an SSD, and/or may operate based on relatively low-level data such as NVMe over fabric (NVMe-oF) data streams. Accordingly, embodiments may operate beyond user and administrative privileges and, may therefore be safe from malicious manipulations of the OS. This protection layer may detect the ransomware as it begins acting based on SSD activity. For example, the protection layer may receive a stream of NVMe commands, and artificial intelligence (AI) or machine-learning (ML) models may be employed to detect use of the storage device for ransomware-related activity. By utilizing behavioral patterns in the sequence/time-series of the NVMe access to disk, embodiments may achieve superior accuracy. In embodiments, based on such ransomware-related activity being detected, a recovery operation may be performed.

Accordingly, embodiments may provide advantages over protections which reside only in the software layer, for example antivirus or firewall software. For example, software-only protections may require different implementations corresponding to multiple different operating systems or computer hardware configurations. In addition, hackers and other creators of malicious software may have significant experience evading such software-only protections.

In contrast, embodiments may provide ransomware protection that is compatible across multiple platforms. In addition, embodiments may reduce a workload of a central processing unit (CPU) of a host by performing, in the storage device, operations that would otherwise be required to be performed by the CPU. Also, embodiments may have access to information that may not be available to software-only protections, for example data included in logically-erased blocks, and therefore may provide increased malware detection and data recovery capabilities.

Although description is provided herein in relation to ransomware detection, embodiments are not limited thereto. For example, embodiments may provide detection of and protection against any type of malware, as desired.

For example, several new cryptocurrencies, for example Filecoin and Chia, use storage resources for their mining, instead of computational resources as for Bitcoin. A crypto-mining attack based on such a cryptocurrency could have devastating effects on a victim's storage device, for example an SSD storage device. In general, storage commands such as Non-Volatile Memory express (NVMe) commands to an SSD, may be executed without any monitoring or filtering. Accordingly, malicious software such as malware can perform storage based crypto-currency mining, occupy storage space on the SSD, and degrade its health by performing multiple program/erase (P/E) cycles. For example, using a victim's SSD device to prepare for Chia mining, a procedure called plotting, can significantly degrade the device's performance, and easily exceed the device's specifications for Terabytes Written, or even wear it out completely in a matter of weeks.

Accordingly, embodiments may be used to detect malicious cryptographic mining or crypto-mining, which may be referred to as crypto-jacking. In embodiments, crypto-mining relates to any operations related to various cryptocurrencies, including but not limited to mining, performing hash operations, storing user data, plotting, farming, etc. In embodiments, based on such crypto-mining being detected, an alert corresponding to the crypto-mining activity may be passed to a software application monitoring the storage device.

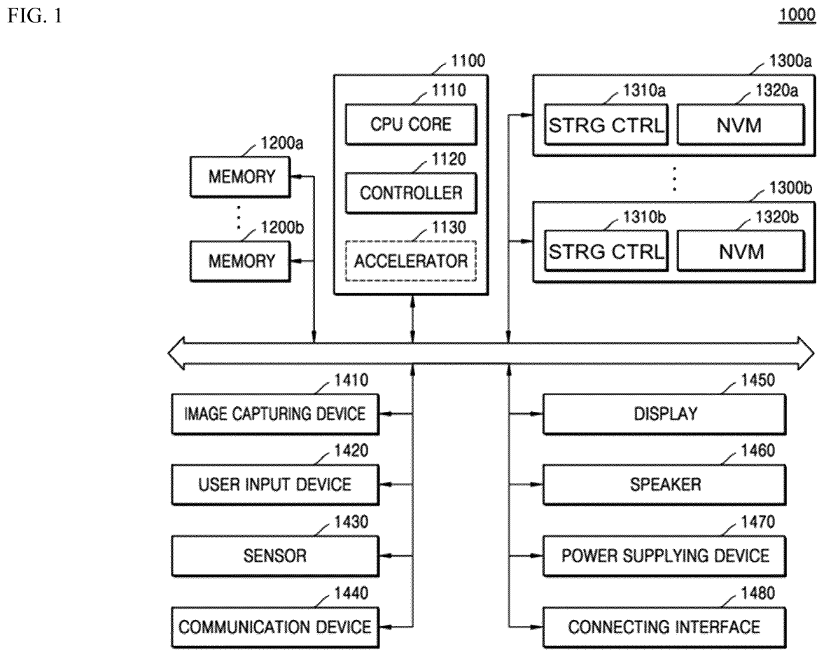

FIG. 1 is a diagram of a system 1000 to which embodiments may be applied. The system 1000 of FIG. 1 may be, for example, a mobile system, such as a portable communication terminal (e.g., a mobile phone), a smartphone, a tablet personal computer (PC), a wearable device, a healthcare device, or an Internet of things (IOT) device. However, the system 1000 of FIG. 1 is not necessarily limited to the mobile system and may be a PC, a laptop computer, a server, a media player, or an automotive device (e.g., a navigation device).

Referring to FIG. 1, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and Non-Volatile Memories (NVMs) 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, embodiments are not limited thereto, and the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of SSDs or memory cards, and may be removably combined with other components of the system 1000 through an interface, such as the connecting interface 1480 described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery (not shown) embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

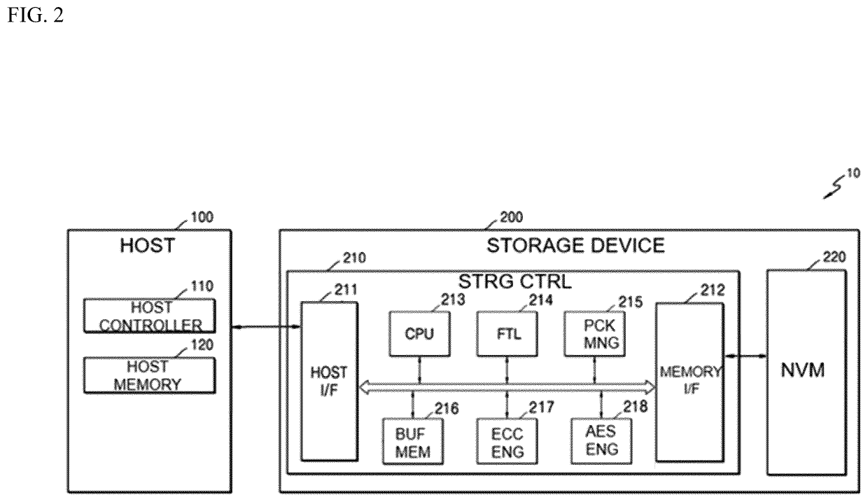

FIG. 2 is a block diagram of a host storage system 10 according to an example embodiment.

The host storage system 10 may include a host 100 and a storage device 200. Further, the storage device 200 may include a storage controller 210 and an NVM 220. According to an example embodiment, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to embodiments, the host controller 110 and the host memory 120 may be implemented as separate semiconductor chips. In some embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory (not shown) in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. More specifically, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

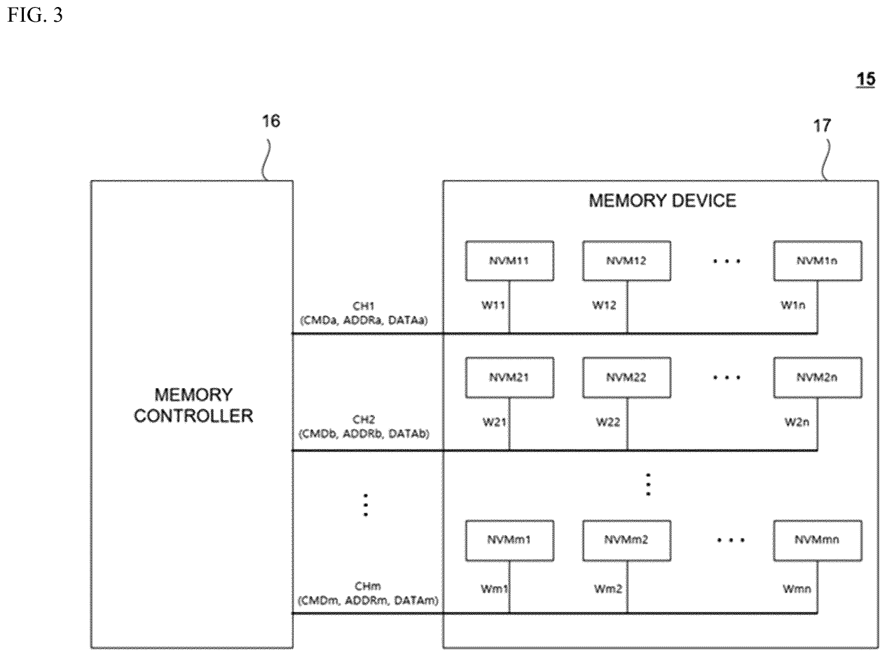

FIG. 3 is a block diagram of a memory system 15 according embodiments. Referring to FIG. 3, the memory system 15 may include a memory device 17 and a memory controller 16. The memory system 15 may support a plurality of channels CH1 to CHm, and the memory device 17 may be connected to the memory controller 16 through the plurality of channels CH1 to CHm. For example, the memory system 15 may be implemented as a storage device, such as an SSD.

The memory device 17 may include a plurality of NVM devices NVM11 to NVMmn. Each of the NVM devices NVM11 to NVMmn may be connected to one of the plurality of channels CH1 to CHm through a way corresponding thereto. For instance, the NVM devices NVM11 to NVM1n may be connected to a first channel CH1 through ways W11 to W1n, and the NVM devices NVM21 to NVM2n may be connected to a second channel CH2 through ways W21 to W2n. In an example embodiment, each of the NVM devices NVM11 to NVMmn may be implemented as an arbitrary memory unit that may operate according to an individual command from the memory controller 16. For example, each of the NVM devices NVM11 to NVMmn may be implemented as a chip or a die, but the inventive concept is not limited thereto.

The memory controller 16 may transmit and receive signals to and from the memory device 17 through the plurality of channels CH1 to CHm. For example, the memory controller 16 may transmit commands CMDa to CMDm, addresses ADDRa to ADDRm, and data DATAa to DATAm to the memory device 17 through the channels CH1 to CHm or receive the data DATAa to DATAm from the memory device 17.

The memory controller 16 may select one of the NVM devices NVM11 to NVMmn, which is connected to each of the channels CH1 to CHm, by using a corresponding one of the channels CH1 to CHm, and transmit and receive signals to and from the selected NVM device. For example, the memory controller 16 may select the NVM device NVM11 from the NVM devices NVM11 to NVM1n connected to the first channel CH1. The memory controller 16 may transmit the command CMDa, the address ADDRa, and the data DATAa to the selected NVM device NVM11 through the first channel CH1 or receive the data DATAa from the selected NVM device NVM11.

The memory controller 16 may transmit and receive signals to and from the memory device 17 in parallel through different channels. For example, the memory controller 16 may transmit a command CMDb to the memory device 17 through the second channel CH2 while transmitting a command CMDa to the memory device 17 through the first channel CH1. For example, the memory controller 16 may receive data DATAb from the memory device 17 through the second channel CH2 while receiving data DATAa from the memory device 17 through the first channel CH1.

The memory controller 16 may control all operations of the memory device 17. The memory controller 16 may transmit a signal to the channels CH1 to CHm and control each of the NVM devices NVM11 to NVMmn connected to the channels CH1 to CHm. For instance, the memory controller 16 may transmit the command CMDa and the address ADDRa to the first channel CH1 and control one selected from the NVM devices NVM11 to NVM1n.

Each of the NVM devices NVM11 to NVMmn may operate via the control of the memory controller 16. For example, the NVM device NVM11 may program the data DATAa based on the command CMDa, the address ADDRa, and the data DATAa provided to the first channel CH1. For example, the NVM device NVM21 may read the data DATAb based on the command CMDb and the address ADDb provided to the second channel CH2 and transmit the read data DATAb to the memory controller 16.

Although FIG. 3 illustrates an example in which the memory device 17 communicates with the memory controller 16 through m channels and includes n NVM devices corresponding to each of the channels, the number of channels and the number of NVM devices connected to one channel may be variously changed.

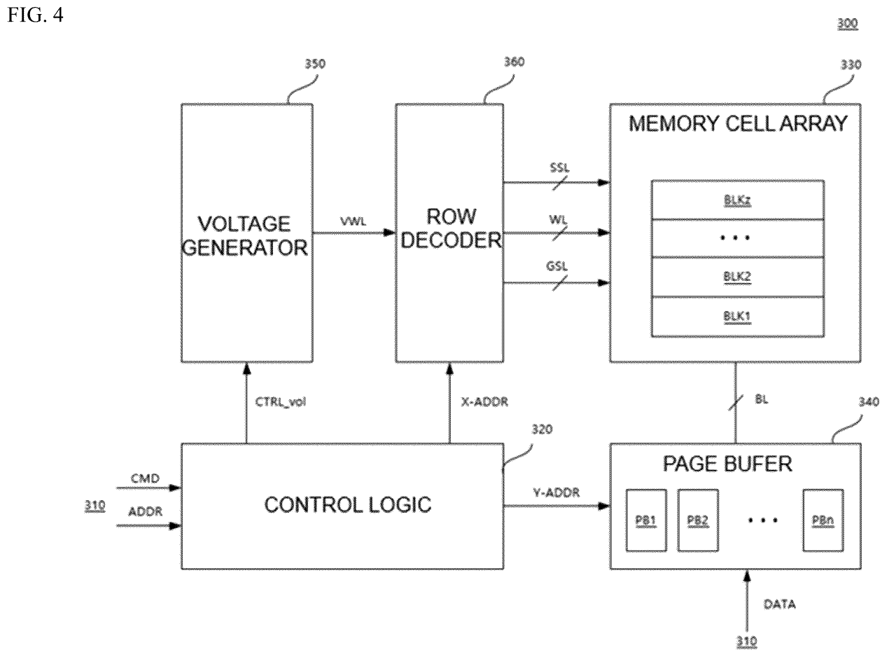

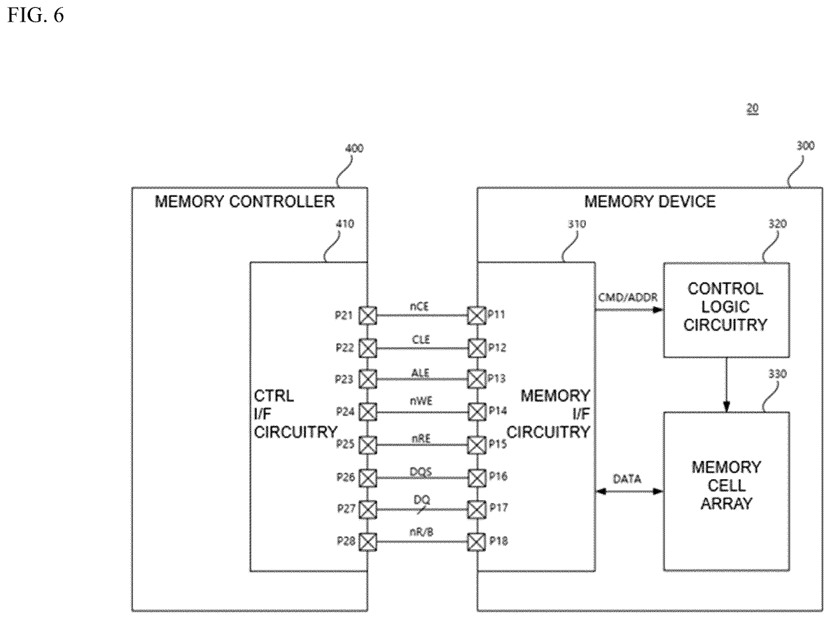

FIG. 4 is a block diagram of a memory device 300 according to an example embodiment. Referring to FIG. 4, the memory device 300 may include a control logic circuitry 320, a memory cell array 330, a page buffer 340, a voltage generator 350, and a row decoder 360. Although not shown in FIG. 4, the memory device 300 may further include a memory interface circuitry 310 shown in FIG. 6. In addition, the memory device 300 may further include a column logic, a pre-decoder, a temperature sensor, a command decoder, and/or an address decoder.

The control logic circuitry 320 may control all various operations of the memory device 300. The control logic circuitry 320 may output various control signals in response to commands CMD and/or addresses ADDR from the memory interface circuitry 310. For example, the control logic circuitry 320 may output a voltage control signal CTRL_vol, a row address X-ADDR, and a column address Y-ADDR.

The memory cell array 330 may include a plurality of memory blocks BLK1 to BLKz (here, z is a positive integer), each of which may include a plurality of memory cells. The memory cell array 330 may be connected to the page buffer 340 through bit lines BL and be connected to the row decoder 360 through word lines WL, string selection lines SSL, and ground selection lines GSL.

In an example embodiment, the memory cell array 330 may include a 3D memory cell array, which includes a plurality of NAND strings. Each of the NAND strings may include memory cells respectively connected to word lines vertically stacked on a substrate. The disclosures of U.S. Pat. Nos. 7,679,133; 8,553,466; 8,654,587; 8,559,235; and US Pat. Pub. No. 2011/0233648 are hereby incorporated by reference. In an example embodiment, the memory cell array 330 may include a 2D memory cell array, which includes a plurality of NAND strings arranged in a row direction and a column direction.

The page buffer 340 may include a plurality of page buffers PB1 to PBn (here, n is an integer greater than or equal to 3), which may be respectively connected to the memory cells through a plurality of bit lines BL. The page buffer 340 may select at least one of the bit lines BL in response to the column address Y-ADDR. The page buffer 340 may operate as a write driver or a sense amplifier according to an operation mode. For example, during a program operation, the page buffer 340 may apply a bit line voltage corresponding to data to be programmed, to the selected bit line. During a read operation, the page buffer 340 may sense current or a voltage of the selected bit line BL and sense data stored in the memory cell.

The voltage generator 350 may generate various kinds of voltages for program, read, and erase operations based on the voltage control signal CTRL_vol. For example, the voltage generator 350 may generate a program voltage, a read voltage, a program verification voltage, and an erase voltage as a word line voltage VWL.

The row decoder 360 may select one of a plurality of word lines WL and select one of a plurality of string selection lines SSL in response to the row address X-ADDR. For example, the row decoder 360 may apply the program voltage and the program verification voltage to the selected word line WL during a program operation and apply the read voltage to the selected word line WL during a read operation.

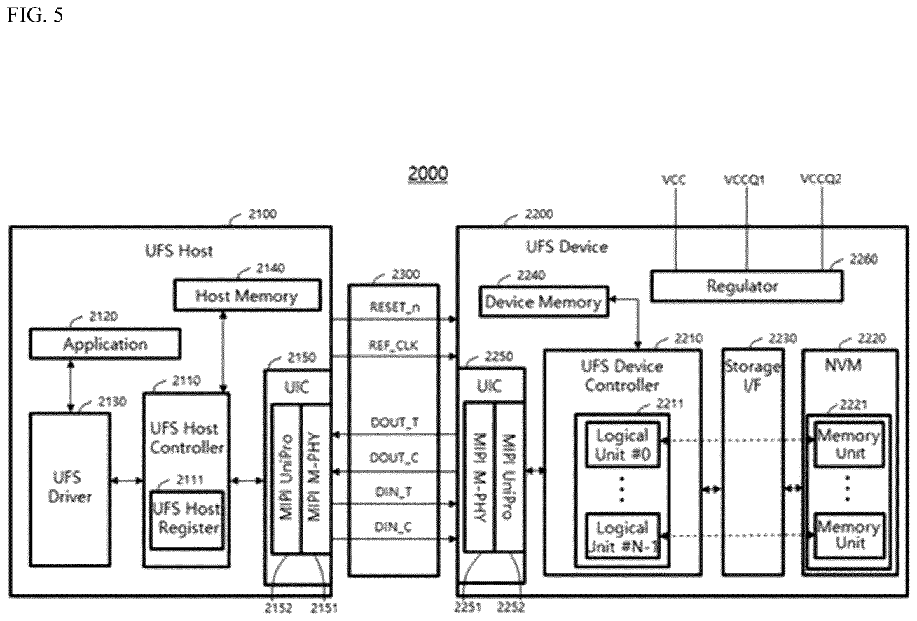

FIG. 5 is a diagram of a UFS system 2000 according to embodiments. The UFS system 2000 may be a system conforming to a UFS standard announced by Joint Electron Device Engineering Council (JEDEC) and include a UFS host 2100, a UFS device 2200, and a UFS interface 2300. The above description of the system 1000 of FIG. 1 may also be applied to the UFS system 2000 of FIG. 5 within a range that does not conflict with the following description of FIG. 5.

Referring to FIG. 5, the UFS host 2100 may be connected to the UFS device 2200 through the UFS interface 2300. When the main processor 1100 of FIG. 1 is an AP, the UFS host 2100 may be implemented as a portion of the AP. The UFS host controller 2110 and the host memory 2140 may respectively correspond to the controller 1120 of the main processor 1100 and the memories 1200a and 1200b of FIG. 1. The UFS device 2200 may correspond to the storage device 1300a and 1300b of FIG. 1, and a UFS device controller 2210 and an NVM 2220 may respectively correspond to the storage controllers 1310a and 1310b and the NVMs 1320a and 1320b of FIG. 1.

The UFS host 2100 may include a UFS host controller 2110, an application 2120, a UFS driver 2130, a host memory 2140, and a UFS interconnect (UIC) layer 2150. The UFS device 2200 may include the UFS device controller 2210, the NVM 2220, a storage interface 2230, a device memory 2240, a UIC layer 2250, and a regulator 2260. The NVM 2220 may include a plurality of memory units 2221. Although each of the memory units 2221 may include a V-NAND flash memory having a 2D structure or a 3D structure, each of the memory units 2221 may include another kind of NVM, such as PRAM and/or RRAM. The UFS device controller 2210 may be connected to the NVM 2220 through the storage interface 2230. The storage interface 2230 may be configured to comply with a standard protocol, such as Toggle or ONFI.

The application 2120 may refer to a program that wants to communicate with the UFS device 2200 to use functions of the UFS device 2200. The application 2120 may transmit input-output requests (IORs) to the UFS driver 2130 for input/output (I/O) operations on the UFS device 2200. The IORs may refer to a data read request, a data storage (or write) request, and/or a data erase (or discard) request, without being limited thereto.

The UFS driver 2130 may manage the UFS host controller 2110 through a UFS-host controller interface (UFS-HCI). The UFS driver 2130 may convert the IOR generated by the application 2120 into a UFS command defined by the UFS standard and transmit the UFS command to the UFS host controller 2110. One IOR may be converted into a plurality of UFS commands. Although the UFS command may basically be defined by an SCSI standard, the UFS command may be a command dedicated to the UFS standard.

The UFS host controller 2110 may transmit the UFS command converted by the UFS driver 2130 to the UIC layer 2250 of the UFS device 2200 through the UIC layer 2150 and the UFS interface 2300. During the transmission of the UFS command, a UFS host register 2111 of the UFS host controller 2110 may serve as a command queue (CQ).

The UIC layer 2150 on the side of the UFS host 2100 may include a mobile industry processor interface (MIPI) M-PHY 2151 and an MIPI UniPro 2152, and the UIC layer 2250 on the side of the UFS device 2200 may also include an MIPIM-PHY 2251 and an MIPI UniPro 2252.

The UFS interface 2300 may include a line configured to transmit a reference clock signal REF_CLK, a line configured to transmit a hardware reset signal RESET_n for the UFS device 2200, a pair of lines configured to transmit a pair of differential input signals DIN_t and DIN_c, and a pair of lines configured to transmit a pair of differential output signals DOUT_t and DOUT_c.

A frequency of a reference clock signal REF_CLK provided from the UFS host 2100 to the UFS device 2200 may be one of 19.2 MHz, 26 MHz, 38.4 MHz, and 52 MHz, without being limited thereto. The UFS host 2100 may change the frequency of the reference clock signal REF_CLK during an operation, that is, during data transmission/receiving operations between the UFS host 2100 and the UFS device 2200. The UFS device 2200 may generate cock signals having various frequencies from the reference clock signal REF_CLK provided from the UFS host 2100, by using a phase-locked loop (PLL). Also, the UFS host 2100 may set a data rate between the UFS host 2100 and the UFS device 2200 by using the frequency of the reference clock signal REF_CLK. That is, the data rate may be determined depending on the frequency of the reference clock signal REF_CLK.

The UFS interface 2300 may support a plurality of lanes, each of which may be implemented as a pair of differential lines. For example, the UFS interface 2300 may include at least one receiving lane and at least one transmission lane. In FIG. 5, a pair of lines configured to transmit a pair of differential input signals DIN_T and DIN_C may constitute a receiving lane, and a pair of lines configured to transmit a pair of differential output signals DOUT_T and DOUT_C may constitute a transmission lane. Although one transmission lane and one receiving lane are illustrated in FIG. 5, the number of transmission lanes and the number of receiving lanes may be changed.

The receiving lane and the transmission lane may transmit data based on a serial communication scheme. Full-duplex communications between the UFS host 2100 and the UFS device 2200 may be enabled due to a structure in which the receiving lane is separated from the transmission lane. That is, while receiving data from the UFS host 2100 through the receiving lane, the UFS device 2200 may transmit data to the UFS host 2100 through the transmission lane. In addition, control data (e.g., a command) from the UFS host 2100 to the UFS device 2200 and user data to be stored in or read from the NVM 2220 of the UFS device 2200 by the UFS host 2100 may be transmitted through the same lane. Accordingly, between the UFS host 2100 and the UFS device 2200, there may be no need to further provide a separate lane for data transmission in addition to a pair of receiving lanes and a pair of transmission lanes.

The UFS device controller 2210 of the UFS device 2200 may control all operations of the UFS device 2200. The UFS device controller 2210 may manage the NVM 2220 by using a logical unit (LU) 2211, which is a logical data storage unit. The number of LUs 2211 may be 8, without being limited thereto. The UFS device controller 2210 may include an FTL and convert a logical data address (e.g., a logical block address (LBA)) received from the UFS host 2100 into a physical data address (e.g., a physical block address (PBA)) by using address mapping information of the FTL. A logical block configured to store user data in the UFS system 2000 may have a size in a predetermined range. For example, a minimum size of the logical block may be set to 4 Kbyte.

When a command from the UFS host 2100 is applied through the UIC layer 2250 to the UFS device 2200, the UFS device controller 2210 may perform an operation in response to the command and transmit a completion response to the UFS host 2100 when the operation is completed.

As an example, when the UFS host 2100 intends to store user data in the UFS device 2200, the UFS host 2100 may transmit a data storage command to the UFS device 2200. When a response (a ‘ready-to-transfer’ response) indicating that the UFS host 2100 is ready to receive user data (ready-to-transfer) is received from the UFS device 2200, the UFS host 2100 may transmit user data to the UFS device 2200. The UFS device controller 2210 may temporarily store the received user data in the device memory 2240 and store the user data, which is temporarily stored in the device memory 2240, at a selected position of the NVM 2220 based on the address mapping information of the FTL.

As another example, when the UFS host 2100 intends to read the user data stored in the UFS device 2200, the UFS host 2100 may transmit a data read command to the UFS device 2200. The UFS device controller 2210, which has received the command, may read the user data from the NVM 2220 based on the data read command and temporarily store the read user data in the device memory 2240. During the read operation, the UFS device controller 2210 may detect and correct an error in the read user data by using an ECC engine (not shown) embedded therein. More specifically, the ECC engine may generate parity bits for write data to be written to the NVM 2220, and the generated parity bits may be stored in the NVM 2220 along with the write data. During the reading of data from the NVM 2220, the ECC engine may correct an error in read data by using the parity bits read from the NVM 2220 along with the read data, and output error-corrected read data.

In addition, the UFS device controller 2210 may transmit user data, which is temporarily stored in the device memory 2240, to the UFS host 2100. In addition, the UFS device controller 2210 may further include an AES engine (not shown). The AES engine may perform at least of an encryption operation and a decryption operation on data transmitted to the UFS device controller 2210 by using a symmetric-key algorithm.

The UFS host 2100 may sequentially store commands, which are to be transmitted to the UFS device 2200, in the UFS host register 2111, which may serve as a common queue, and sequentially transmit the commands to the UFS device 2200. In this case, even while a previously transmitted command is still being processed by the UFS device 2200, that is, even before receiving a notification that the previously transmitted command has been processed by the UFS device 2200, the UFS host 2100 may transmit a next command, which is on standby in the CQ, to the UFS device 2200. Thus, the UFS device 2200 may also receive a next command from the UFS host 2100 during the processing of the previously transmitted command. A maximum number (or queue depth) of commands that may be stored in the CQ may be, for example, 32. Also, the CQ may be implemented as a circular queue in which a start and an end of a command line stored in a queue are indicated by a head pointer and a tail pointer.

Each of the plurality of memory units 2221 may include a memory cell array (not shown) and a control circuit (not shown) configured to control an operation of the memory cell array. The memory cell array may include a 2D memory cell array or a 3D memory cell array.

The memory cell array may include a plurality of memory cells. Although each of the memory cells is a single-level cell (SLC) configured to store 1-bit information, each of the memory cells may be a cell configured to store information of 2 bits or more, such as a multi-level cell (MLC), a triple-level cell (TLC), and a quadruple-level cell (QLC). The 3D memory cell array may include a vertical NAND string in which at least one memory cell is vertically oriented and located on another memory cell.

Voltages VCC, VCCQ, and VCCQ2 may be applied as power supply voltages to the UFS device 2200. The voltage VCC may be a main power supply voltage for the UFS device 2200 and be in a range of 2.4 V to 3.6 V. The voltage VCCQ may be a power supply voltage for supplying a low voltage mainly to the UFS device controller 2210 and be in a range of 1.14 V to 1.26 V. The voltage VCCQ2 may be a power supply voltage for supplying a voltage, which is lower than the voltage VCC and higher than the voltage VCCQ, mainly to an I/O interface, such as the MIPI M-PHY 2251, and be in a range of 1.7 V to 1.95 V. The power supply voltages may be supplied through the regulator 2260 to respective components of the UFS device 2200. The regulator 2260 may be implemented as a set of unit regulators respectively connected to different ones of the power supply voltages described above.

FIG. 6 is a block diagram of a memory system 20 according to embodiments. Referring to FIG. 6, the memory system 20 may include a memory device 300 and a memory controller 400. The memory device 300 may correspond to one of NVM devices NVM11 to NVMmn, which communicate with a memory controller 200 based on one of the plurality of channels CH1 to CHm of FIG. 3. The memory controller 400 may correspond to the memory controller 200 of FIG. 3.

The memory device 300 may include first to eighth pins P11 to P18, a memory interface circuitry 310, a control logic circuitry 320, and a memory cell array 330.

The memory interface circuitry 310 may receive a chip enable signal nCE from the memory controller 400 through the first pin P11. The memory interface circuitry 310 may transmit and receive signals to and from the memory controller 400 through the second to eighth pins P12 to P18 in response to the chip enable signal nCE. For example, when the chip enable signal nCE is in an enable state (e.g., a low level), the memory interface circuitry 310 may transmit and receive signals to and from the memory controller 400 through the second to eighth pins P12 to P18.

The memory interface circuitry 310 may receive a command latch enable signal CLE, an address latch enable signal ALE, and a write enable signal nWE from the memory controller 400 through the second to fourth pins P12 to P14. The memory interface circuitry 310 may receive a data signal DQ from the memory controller 400 through the seventh pin P17 or transmit the data signal DQ to the memory controller 400. A command CMD, an address ADDR, and data may be transmitted via the data signal DQ. For example, the data signal DQ may be transmitted through a plurality of data signal lines. In this case, the seventh pin P17 may include a plurality of pins respectively corresponding to a plurality of data signals DQ(s).

The memory interface circuitry 310 may obtain the command CMD from the data signal DQ, which is received in an enable section (e.g., a high-level state) of the command latch enable signal CLE based on toggle time points of the write enable signal nWE. The memory interface circuitry 310 may obtain the address ADDR from the data signal DQ, which is received in an enable section (e.g., a high-level state) of the address latch enable signal ALE based on the toggle time points of the write enable signal nWE.

In an example embodiment, the write enable signal nWE may be maintained at a static state (e.g., a high level or a low level) and toggle between the high level and the low level. For example, the write enable signal nWE may toggle in a section in which the command CMD or the address ADDR is transmitted. Thus, the memory interface circuitry 310 may obtain the command CMD or the address ADDR based on toggle time points of the write enable signal nWE.

The memory interface circuitry 310 may receive a read enable signal nRE from the memory controller 400 through the fifth pin P15. The memory interface circuitry 310 may receive a data strobe signal DQS from the memory controller 400 through the sixth pin P16 or transmit the data strobe signal DQS to the memory controller 400.

In a data (DATA) output operation of the memory device 300, the memory interface circuitry 310 may receive the read enable signal nRE, which toggles through the fifth pin P15, before outputting the data. The memory interface circuitry 310 may generate the data strobe signal DQS, which toggles based on the toggling of the read enable signal nRE. For example, the memory interface circuitry 310 may generate a data strobe signal DQS, which starts toggling after a predetermined delay (e.g., tDQSRE), based on a toggling start time of the read enable signal nRE. The memory interface circuitry 310 may transmit the data signal DQ including the data DATA based on a toggle time point of the data strobe signal DQS. Thus, the data DATA may be aligned with the toggle time point of the data strobe signal DQS and transmitted to the memory controller 400.

In a data (DATA) input operation of the memory device 300, when the data signal DQ including the data DATA is received from the memory controller 400, the memory interface circuitry 310 may receive the data strobe signal DQS, which toggles, along with the data DATA from the memory controller 400. The memory interface circuitry 310 may obtain the data DATA from the data signal DQ based on toggle time points of the data strobe signal DQS. For example, the memory interface circuitry 310 may sample the data signal DQ at rising and falling edges of the data strobe signal DQS and obtain the data DATA.

The memory interface circuitry 310 may transmit a ready/busy output signal nR/B to the memory controller 400 through the eighth pin P18. The memory interface circuitry 310 may transmit state information of the memory device 300 through the ready/busy output signal nR/B to the memory controller 400. When the memory device 300 is in a busy state (i.e., when operations are being performed in the memory device 300), the memory interface circuitry 310 may transmit a ready/busy output signal nR/B indicating the busy state to the memory controller 400. When the memory device 300 is in a ready state (i.e., when operations are not performed or completed in the memory device 300), the memory interface circuitry 310 may transmit a ready/busy output signal nR/B indicating the ready state to the memory controller 400. For example, while the memory device 300 is reading data DATA from the memory cell array 330 in response to a page read command, the memory interface circuitry 310 may transmit a ready/busy output signal nR/B indicating a busy state (e.g., a low level) to the memory controller 400. For example, while the memory device 300 is programming data DATA to the memory cell array 330 in response to a program command, the memory interface circuitry 310 may transmit a ready/busy output signal nR/B indicating the busy state to the memory controller 400.

The control logic circuitry 320 may control all operations of the memory device 300. The control logic circuitry 320 may receive the command/address CMD/ADDR obtained from the memory interface circuitry 310. The control logic circuitry 320 may generate control signals for controlling other components of the memory device 300 in response to the received command/address CMD/ADDR. For example, the control logic circuitry 320 may generate various control signals for programming data DATA to the memory cell array 330 or reading the data DATA from the memory cell array 330.

The memory cell array 330 may store the data DATA obtained from the memory interface circuitry 310, via the control of the control logic circuitry 320. The memory cell array 330 may output the stored data DATA to the memory interface circuitry 310 via the control of the control logic circuitry 320.

The memory cell array 330 may include a plurality of memory cells. For example, the plurality of memory cells may be flash memory cells. However, the inventive concept is not limited thereto, and the memory cells may be RRAM cells, FRAM cells, PRAM cells, thyristor RAM (TRAM) cells, or MRAM cells. Hereinafter, an embodiment in which the memory cells are NAND flash memory cells will mainly be described.

The memory controller 400 may include first to eighth pins P21 to P28 and a controller interface circuitry 410. The first to eighth pins P21 to P28 may respectively correspond to the first to eighth pins P11 to P18 of the memory device 300.

The controller interface circuitry 410 may transmit a chip enable signal nCE to the memory device 300 through the first pin P21. The controller interface circuitry 410 may transmit and receive signals to and from the memory device 300, which is selected by the chip enable signal nCE, through the second to eighth pins P22 to P28.

The controller interface circuitry 410 may transmit the command latch enable signal CLE, the address latch enable signal ALE, and the write enable signal nWE to the memory device 300 through the second to fourth pins P22 to P24. The controller interface circuitry 410 may transmit or receive the data signal DQ to and from the memory device 300 through the seventh pin P27.

The controller interface circuitry 410 may transmit the data signal DQ including the command CMD or the address ADDR to the memory device 300 along with the write enable signal nWE, which toggles. The controller interface circuitry 410 may transmit the data signal DQ including the command CMD to the memory device 300 by transmitting a command latch enable signal CLE having an enable state. Also, the controller interface circuitry 410 may transmit the data signal DQ including the address ADDR to the memory device 300 by transmitting an address latch enable signal ALE having an enable state.

The controller interface circuitry 410 may transmit the read enable signal nRE to the memory device 300 through the fifth pin P25. The controller interface circuitry 410 may receive or transmit the data strobe signal DQS from or to the memory device 300 through the sixth pin P26.

In a data (DATA) output operation of the memory device 300, the controller interface circuitry 410 may generate a read enable signal nRE, which toggles, and transmit the read enable signal nRE to the memory device 300. For example, before outputting data DATA, the controller interface circuitry 410 may generate a read enable signal nRE, which is changed from a static state (e.g., a high level or a low level) to a toggling state. Thus, the memory device 300 may generate a data strobe signal DQS, which toggles, based on the read enable signal nRE. The controller interface circuitry 410 may receive the data signal DQ including the data DATA along with the data strobe signal DQS, which toggles, from the memory device 300. The controller interface circuitry 410 may obtain the data DATA from the data signal DQ based on a toggle time point of the data strobe signal DQS.

In a data (DATA) input operation of the memory device 300, the controller interface circuitry 410 may generate a data strobe signal DQS, which toggles. For example, before transmitting data DATA, the controller interface circuitry 410 may generate a data strobe signal DQS, which is changed from a static state (e.g., a high level or a low level) to a toggling state. The controller interface circuitry 410 may transmit the data signal DQ including the data DATA to the memory device 300 based on toggle time points of the data strobe signal DQS.

The controller interface circuitry 410 may receive a ready/busy output signal nR/B from the memory device 300 through the eighth pin P28. The controller interface circuitry 410 may determine state information of the memory device 300 based on the ready/busy output signal nR/B.

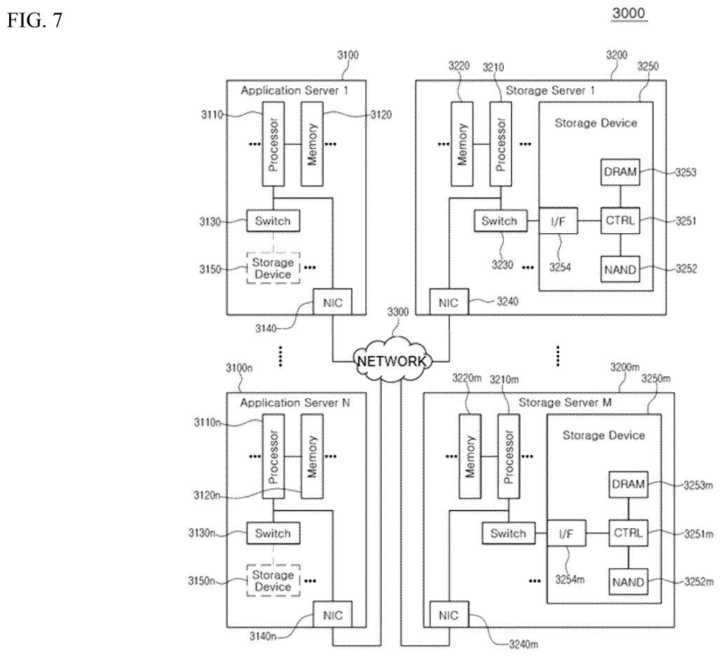

FIG. 7 is a diagram of a data center 3000 to which a memory device is applied, according to embodiments.

Referring to FIG. 7, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some embodiments, the numbers of processors 3210 and memories 3220 included in the storage server 3200 may be variously selected. In embodiments, the processor 3210 and the memory 3220 may provide a processor-memory pair. In embodiments, the number of processors 3210 may be different from the number of memories 3220. The processor 3210 may include a single-core processor or a multi-core processor. The above description of the storage server 3200 may be similarly applied to the application server 3100. In some embodiments, the application server 3100 may not include a storage device 3150. The storage server 3200 may include at least one storage device 3250. The number of storage devices 3250 included in the storage server 3200 may be variously selected according to embodiments.

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In embodiments, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another embodiment, the network 3300 may be a general network, such as a TCP/IP network. For example, the network 3300 may be implemented according to a protocol, such as FC over Ethernet (FCOE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC(Network InterConnect) 3240. The switch 3230 may selectively connect the processor 3210 to the storage device 3250 or selectively connect the NIC 3240 to the storage device 3250 via the control of the processor 3210.

In embodiments, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In embodiments, the NIC 3240 may be integrated with at least one of the processor 3210, the switch 3230, and the storage device 3250.

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 3251 may control all operations of the storage device 3250. In embodiments, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

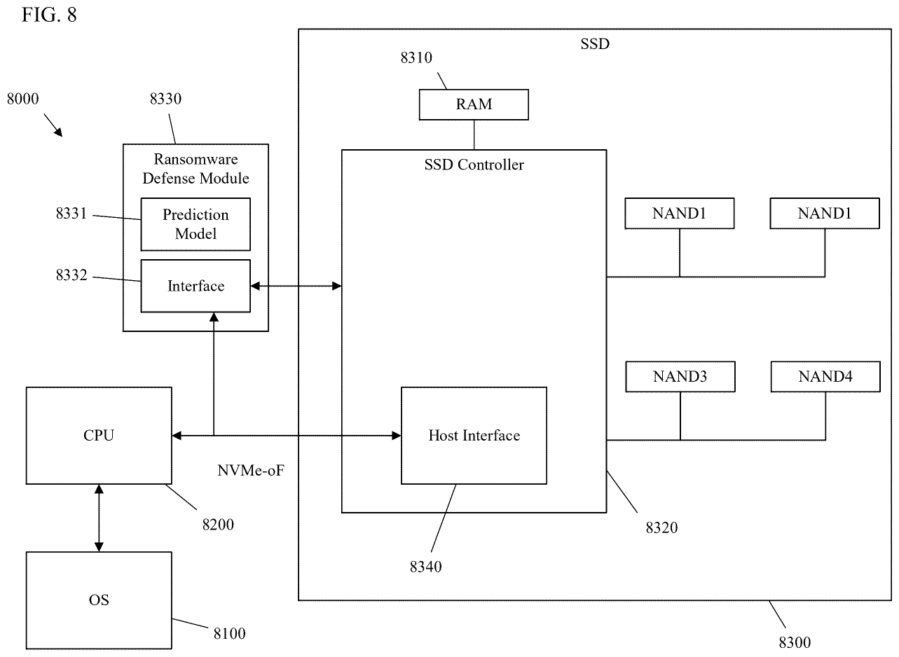

FIG. 8 is an example of a storage system 8000, according to embodiments. The storage system 8000 may include a CPU 8200 which may be used to operate an operating system (OS) 8100, and may include an SSD 8300. In embodiments, the CPU 8200 may correspond to, for example, the main processor 1100, the CPU core 1110, the host controller 110, the UFS host controller 2110, the processors 3210 and 3210m, the processors 3110 and 3110n, or any other element discussed above. In embodiments, the SSD 8300 may correspond to the storage devices 1300a and 1300b, the storage device 200, the memory system 15, the memory system 20, the memory device 300, the storage servers 3200 or 3200m, or any other element discussed above. Although the SSD 8300 is illustrated as an SSD, embodiments may also be applied to any other type of storage device, for example a UFS storage device such as the UFS device 2200, or any other storage device such as an eMMC storage device. In embodiments, the CPU 8200 may communicate with a storage device, for example the SSD 8300, using a communication pathway such as a NVMe-oF, however embodiments are not limited thereto, and CPU 8200 may communicate with any type of storage device over any type of connection.

The SSD 8300 may include a RAM 8310, an SSD controller 8320, and one or more memory devices such as NAND flash memory devices NAND1, NAND2, NAND3, and NAND4. In embodiments, the RAM 8310 may correspond to the buffer memory 216, the device memory 2240, or any other element discussed above. In embodiments, the SSD controller 8320 may correspond to the STRG CTRL 1310a and 1310b, the STRG CTRL 210, memory controller 16, the UFS device controller 2210, the memory controller 400, or any other element described above. In embodiments, the memory devices NAND1, NAND2, NAND3, and NAND4 may correspond to the NVMs 1320a and 1320b, the NVM 220, the NVM devices NVM11-NVMmn, the memory device 300, the NVM 2220, or any other element described above.

In embodiments, the SSD controller 8320 may include a host interface 8340, which may correspond to the host interface 211, the UIC layer 2250, or any other element discussed above.

In embodiments, the storage system 8000 may include a ransomware defense module 8330. In embodiments, the ransomware defense module 8330 may be used to provide protection from malicious ransomware attacks. For example, according to embodiments, data such as NVMe commands may be provided to the ransomware defense module 8330, for example by the SSD controller 8320 and/or in parallel with the host interface 8340, and the ransomware defense module 8330 may detect ransomware attacks (e.g., malicious commands generated by ransomware software) based on the data, and may perform corresponding recovery operations, for example at least one of alerting a user of the ransomware attack, removing the ransomware, removing data written by the ransomware, and restoring data which was erased or encrypted by the ransomware, but embodiments are not limited thereto.

In embodiments, the ransomware defense module 8330 may include, for example, AI processor which may perform one or more functions of the ransomware defense module 8330. In embodiments, the AI processor may be, for example, a general purpose AI processor which may execute software code or firmware code, for example firmware code for providing protection from ransomware or other malware. For example, as shown in FIG. 8, the ransomware defense module 8330 may include a prediction model 8331, which may be, or may include, an AI model or an ML model, but embodiments are not limited thereto. In addition, the ransomware defense module 8330 may further include an interface 8332, may be used to communicate with the SSD 8300, the CPU 8200, or any other device, for example in order to receive data such as the NVMe commands, and to perform the recovery operations and/or transmit information corresponding to the recovery operations.

Although FIG. 8 illustrates an example in which the ransomware defense module 8330 is a separate device from the SSD 8300 and the CPU 8200, embodiments are not limited thereto. For example, in some embodiments the ransomware defense module 8330 may be included in the SSD 8300, or for example in the SSD controller 8320, or in any other device (e.g., a host device such as a device including the CPU 8200).

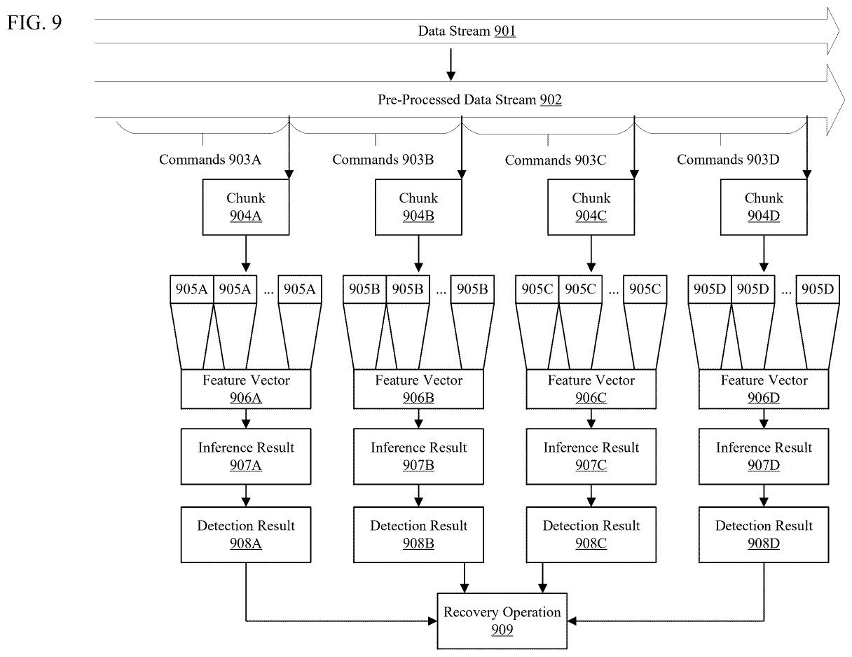

FIG. 9 shows an example of a logical flow of a process for ransomware defense, according to embodiments. As shown in FIG. 9, the ransomware defense module 8330 may receive a data stream 901 as input. According to embodiments, the data stream 901 may be, for example, an NVMe-oF data stream of which includes a plurality of NVMe commands, which may also be referred to as an NVMe-oF command stream or a command stream. Such data may have a relatively low number of attributes. For example, according to some embodiments, the attributes for each command included in the data stream 901 may include at least one of a command timestamp, a command logical block size, a command logical block position, and a command opcode (which may, for example, indicate whether the command is a read command or write command). Other attributes may include, for example, a the host identifier, a command identifier, a namespace identifier, etc.

The raw data stream 901 may be pre-processed, for example by the ransomware defense module 8330, to generate additional data for one or more of the commands, which may be added to the data stream 901 to obtain a pre-processed data stream 902. In embodiments, the pre-processed data stream 902 may also be referred to as a pre-processed command stream.

According to embodiments, the additional data for each command may relate to other commands included in the data stream 901. For example, for a command encountered at a particular timestamp, the pre-processing may add additional attributes, such as a disk overlap of the command with a previous command which occurred at a previous timestamp in the same disk area. Accordingly, embodiments may use the time-series nature of the data stream 901, and may derive from this features which reflect the way the data changes as the sequence advances, and various correlations between the sequence attributes between a current command and past commands. Also, because the commands may include two opcodes (e.g., read and write), the pre-processing may provide four different types or sets of attributes (e.g., different attributes for read-read commands, write-write commands, read-write commands, and write-read commands).

After the pre-processed data stream 902 is obtained, the system may accumulate data included in the pre-processed data stream 902 into a plurality of chunks 904 (e.g., a first chunk 904A, a second chunk 904B, a third chunk 904C, a fourth chunk 904D, etc.). Each chunk 904 may be uniform in at least one dimension or attribute. For example, one accumulation collected by the ransomware defense module 9330 may include chunks 904 having identical time-spans, and other accumulations may be performed along the dimensions of the number of commands in each chunk 904, or an amount of data accumulated in each chunk 904. For example, according to embodiments, the number of commands in each chunk 904 may be on the order of 1000-10,000, or even larger.

According to embodiments, the ransomware defense module 8330 may use the series aspect of the NVMe commands to detect ransomware attacks (e.g., malicious commands). In order to do so, each chunk 904 may be divided by the ransomware defense module 8330 into a plurality of tokens 905. For example, the first chunk 904A may be divided into a first plurality of tokens 905A, the second chunk 904B may be divided into a second plurality of tokens 905B, the third chunk 904C may be divided into a third plurality of tokens 905C, the fourth chunk 904D may be divided into a fourth plurality of tokens 905D, and so on. In embodiments, the number of tokens 905 into which each chunk 904 is divided may be denoted T.

Each token 905 may be defined by the set of commands within a given sliding window that slides across the series as the series progress. The size of the sliding window may be fixed with respect to a particular attribute, for example a number of commands in each token 905, an amount of read/write data described in each token 905 (e.g., a number of logical blocks (NLB) volume), or a time extent corresponding to each token 905. In addition, the stride by which the sliding window is propagated from one token 905 to another token 905 may be a parameter of choice, and may control an overlap between tokens 905. For example, according to embodiments, the number of NVMe commands per token 905 may be, on average, the number of commands per chunk 904, divided by the number of tokens 905, which may be for example on the order of hundreds.

To prepare the tokens 905 to be provided as input to the prediction model 8331, the ransomware defense module 8330 may perform token embedding of each token 905 into a space of dimension D. This embedding may be learned, and may also be set or adjusted by a user. For example, for the commands within each token 905, the ransomware defense module may calculate embedding feature dimensions such as a number/volume of commands of different types, and statistics such as rate of commands (e.g. number or volume of read commands per unit time) and disk location of commands. For example, the statistics may be concise (e.g. a few moments like the average and standard deviation) or may be more elaborate (e.g. a full histogram of the command rate). Also, the histograms and corresponding moments may be weighted or not (e.g. by the data size that the command corresponds to), and may be applied to various types of commands. According to embodiments, the types of commands may include, for example, read commands, write commands, write after read (WAR) commands or overwrite commands, read after read (RAR) commands or over-read commands, read after write (RAW) commands, write after write (WAW) commands, and commands that do not fall into any of these categories. For example, according to embodiments, the ransomware defense module 8330 may form histogram features for both the command rate and command disk location to reflect histograms with bin sizes of the order of 10-20, and the token embedding dimension D may be on the order of a few hundred, but embodiments are not limited thereto.

According to embodiments, in order to make the embedding generalizable these attributes may be normalized by their typical size, which may allow the ransomware defense module 8330 and/or the prediction model 8331 to be makes transferrable to different systems, for example a system with different CPU and disk namespaces.

After the embeddings are obtained, the ransomware defense module 8330 may aggregate or combine the embeddings corresponding to all of the tokens 905 included in a particular chunk 904 to generate a corresponding feature vector 906. For example, the first plurality of tokens 905A may be combined into a first feature vector 906A corresponding to the first chunk 904A, the second plurality of tokens 905B may be combined into a second feature vector 906B corresponding to the second chunk 904B, the third plurality of tokens 905C may be combined into a third feature vector 906C corresponding to the third chunk 904C, the fourth plurality of tokens 905D may be combined into a fourth feature vector 906D corresponding to the fourth chunk 904D, and so on. In embodiments, each feature vector 906 may have dimensions T×D, where T denotes a number of tokens 905 into which the corresponding chunk 904 is divided, and D denotes a dimension of the embeddings for each token 905.

According to embodiments, the feature vector 906 may be provided as input to the prediction model 8331, which may generate an inference result 907 corresponding to the chunk 904. The inference result 907 may be used by the ransomware defense module 8330 to obtain a detection result 908, which may indicate whether or not a ransomware attack (e.g., a malicious command) has been detected, and may also indicate additional information about the ransomware attack, for example a number of the malicious commands and/or an amount of read/write data corresponding to the malicious commands. For example, the first feature vector 906A may be used to obtain a first inference result 907A, which may be used to obtain a first detection result 908A, the second feature vector 906B may be used to obtain a second inference result 907B, which may be used to obtain a second detection result 908B, the third feature vector 906C may be used to obtain a third inference result 907C, which may be used to obtain a third detection result 908C, the fourth feature vector 906D may be used to obtain a fourth inference result 907D, which may be used to obtain a fourth detection result 908D, and so on. Although examples are provided herein in which the ransomware defense module 8330 obtains both inference results 907 and detection results 908, embodiments are not limited thereto. For example, in some embodiments, the ransomware defense module 8330 may generate only a single result, which may be for example one of the inference result 907 or the detection result 908 or a combination thereof, or may generate other types of results.

In some embodiments, the smallest unit of data on which the ransomware defense module 8330 may operate is the chunk level. This may mean that the prediction model 8331 may be first applied to one chunk 904 at a time, and a recovery operation 909 may be triggered according to the detection result 908 corresponding to each chunk 904. However, the ransomware defense module 8330 may operate based on a plurality of chunks 904. For example, a plurality of inference results 906 (e.g., a classification or regression) provided by the prediction model 8331 may be aggregated and used by the ransomware defense module 8330 to obtain a single detection result 908, which may then be used to trigger a recovery operation 909. According to embodiments, the prediction model 8331 may be trained using a dataset including known benign and malicious commands.

According to embodiments, the prediction model 8331 may provide different types of inference results 907. For example, an inference result 907 may include a single label classified for the corresponding chunk 904. In embodiments, classifying a label for the chunk 904 may refer to applying the label to the chunk 904, or providing or obtaining the label for the chunk 904. In embodiments, the label may indicate a predicted presence or absence of malicious commands within, or corresponding to, a particular chunk 904. For example, a chunk 904 which is predicted to include at least one malicious NVMe command may be classified with a label having a value of one (“1”), and a chunk 904 which is predicted to not include any malicious NVMe commands may be classified with a label having a value of zero (“0”). However, embodiments are not limited thereto, the labels may be classified, applied, or provided, in any manner. As another example, the inference result 907 may include single label classified for each token 905 included in the chunk 904. Accordingly, the inference result 907 may include a plurality of labels corresponding to the chunk 904.

As a further example, the inference result 907 may include a single regression value for each token 905. In embodiments, the regression value may indicate a number of malicious NVMe commands corresponding to the token 905, or for example an amount of data corresponding to the malicious NVMe commands. In embodiments, the regression value may be in a range from a value of zero (“0”) to a value of one (“1”), but embodiments are not limited thereto. As yet another example, the inference result 907 may include several regression values for each token 905. For example, each regression value may reflect a number of malicious NVMe commands of a particular type (for example the malicious read volume and the malicious write volume).

According to embodiments, a type of the detection result 908 may correspond to the type of the inference result 907. For example, if the ransomware defense module 8330 is only used to detect a ransomware attack (e.g., malicious commands), and is not being used to the amount of data that is read and written by the ransomware), then the inference result 907 provided by the prediction model 8331 may only generate a label or a plurality of labels as the inference result 907 corresponding to a chunk 904, and the detection result 908 may be, for example, a “positive” or “negative” result for the chunk 904 (or for a particular token 905), but embodiments are not limited thereto. According to embodiments, the additional processing steps may be used to define what is meant by a “positive” or “negative” detection result 908 for a particular chunk 904 or token 905. For example, the amount/volume of malicious commands within a given data particular chunk 904 or token 905 (as indicated by the inference result 907) may be compared to a threshold in order to obtain the detection result 908. For example, based on an inference result 907 indicating that a chunk 904 contains at least one malicious command, the ransomware defense module 8330 may generate a “positive” detection result 908 which indicates that the chunk 904 is a ransomware chunk. However, this is only an example, and embodiments are not limited thereto. For example, the detection result 908 may be

[symbol]

According to embodiments, the ransomware defense module 8330 may perform, or may trigger, a recovery operation 909 based on the one or more detection results 908. For example, based on the one or more detection results 908 indicating that a ransomware attack has been detected, the ransomware defense module 8330 may perform, or may cause another element to perform, a recovery operation 909. According to embodiments, the recovery operation 909 may include, for example, at least one of alerting a user of the ransomware attack, removing the ransomware, removing data written by the ransomware, and restoring data which was erased or encrypted by the ransomware, but embodiments are not limited thereto.

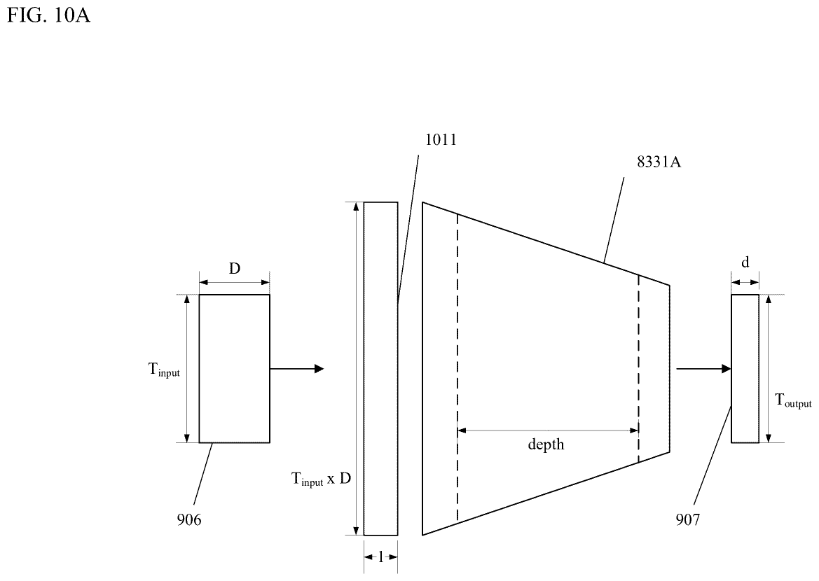

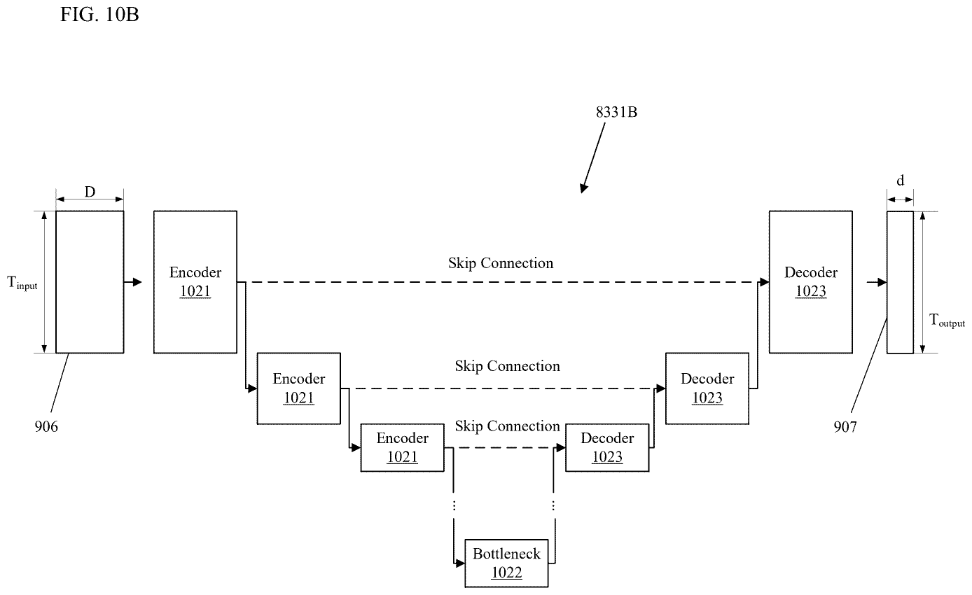

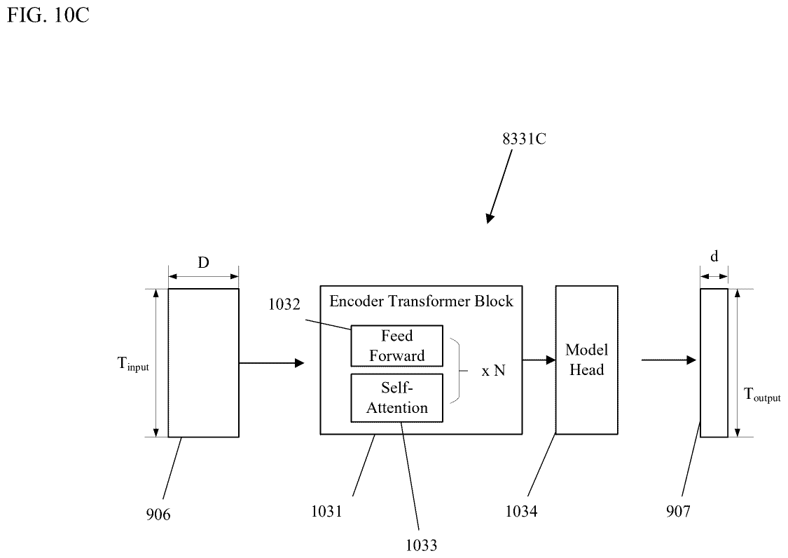

FIGS. 10A-10C illustrate examples of prediction models which may be used for detecting ransomware attacks, according to embodiments. In particular, FIG. 10A is a block diagram illustrating a prediction model 8331A, FIG. 10B is a block diagram illustrating a prediction model 8331B, and FIG. 10C is a block diagram illustrating a prediction model 8331C, each of which may be example configurations of the prediction model 8331 described above.

As shown in FIGS. 10A-10C, each of the prediction models 8331A, 8331B, and 8331C may receive as input a feature vector 906, and may output an inference result 907. According to embodiments, the input feature vector 906 may have dimensions Tᵢₙₚᵤₜ×D, where Tᵢₙₚᵤₜ denotes a number of tokens 905 into which the corresponding chunk 904 is divided, and D denotes a dimension of the embeddings for each token 905. According to embodiments, the inference result 907 may be a feature vector with a dimension Tₒᵤₜₚᵤₜ×d. According to embodiments, Tₒᵤₜₚᵤₜ may be equal to one (e.g., when only a single label is provided or a single regression value is provided for each chunk 904) or may be equal to Tᵢₙₚᵤₜ (e.g., when one or more labels or regression values are provided for each token 905). In this case, d may denote a number of labels provided for each token.

As shown in FIG. 10A, the prediction model 8331A may be, or may include, a fully-connected neural network. In embodiments, the prediction model 8331A may receive as input a flattened vector 1011, which may be obtained by flattening the embedding features included in the feature vector 906. For example, as shown in FIG. 10A, the flattened vector 1011 may be a one-dimensional vector having a length of Tᵢₙₚᵤₜ×D, but embodiments are not limited thereto. The depth of the neural network and the activation functions used by the individual layers may be configurable.

As shown in FIG. 10B, the prediction model 8331B may be a convolutional neural network arranged according to a U-Net architecture. According to embodiments, the prediction model 8331B may be used to obtain inference results 907 which include one or more regression values, a described above. In embodiments, the prediction model 8331B may include a plurality of encoder blocks 1021, a bottleneck block 1022, and a plurality of decoder blocks 1023. Each of the encoder blocks 1021 and the decoder blocks 1023 may include, for example, at least one from among (i) a set of N one-dimensional convolutional blocks with varying filter sizes k1, k2, . . . , kN; (ii) a self-attention module preceded by an addition with a rotational positional encoding; (iii) a residual network (ResNet) block in which a residual connection includes a 1×1 convolution block, followed by one-dimensional convolution having a kernel size of kresnet>1, and another 1×1 convolution block; and (iv) a combination of (i), (ii), (iii) at any given order, and repeated any number of times. The Unet architecture. Here Toutput can either obey Toutput=1 (case 1a or 1c) or Toutput=Tinput (case 1b and 1d). The depth of the Unet is configurable as are the activation functions the individual layers use and the individual encoder and decoder blocks. The red lines denote reduction in the series dimension via pooling (decreasing T). The blue lines denote operations that increase the sequence length (e.g. transpose convolutions). The dashed lines denote skip connections. An example for the encoding and decoding blocks is a series of resent blocks or a series of convolutions and self-attentions blocks.

For example, according to embodiments, each encoder block 1021 and each decoder block 1023 may include several CNN layers, together with nonlinear activations, internal skip connections, and batch normalizations layers, and the encoder blocks 1021 may also include self-attention blocks. The purpose of these blocks is to digest the incoming data and, coming at an embedding dimension D and a sequence length Tᵢₙₚᵤₜ and compute from them a sequence at the same length (e.g., Tₒᵤₜₚᵤₜ=Tᵢₙₚᵤₜ) but at a possibly different embedding (e.g., d=2×D). The down facing arrows shown in FIG. 10B may denote pooling operations along the temporal direction (e.g. maxpool or mean pool) in order to probe the command sequence at a lower resolution by reducing the sequence resolution and outputting a lower number of tokens for the lower U-Net levels. The upward-facing arrows may denote transpose convolution operations along the temporal direction in order to re-introduce a higher sequence resolution and increase the number of tokens 905 while climbing up the U-Net towards the original sequence resolution. The skip connections (illustrated as horizontal dashed lines) may denote data at a particular resolution (for example, the highest, original, resolution of the incoming U-Net level) that traverses from an encoder block 1021 to a decoder block 1023. This data may then be merged (for example by concatenation) with the data flowing from lower U-Net levels to serve as input to the corresponding decoder block 1023.

As shown in FIG. 10C, the prediction model 8331C may be a transformer model. In embodiments, the prediction model 8331C may include an encoder transformer block 1031, which may include one or more feed forward blocks 1032 and self-attention blocks 1033. In some embodiments, the feed forward blocks 1032 and self-attention blocks 1033 may be repeated any number of times, for example N times. The output of the encoder transformer block 1031 may be provided as input to a model head 1034, which may then generate the inference result 907. In the example shown in FIG. 10C, Tₒᵤₜₚᵤₜ may be equal to one (e.g., when only a single label is provided or a single regression value is provided for each chunk 904) or may be equal to f(Tᵢₙₚᵤₜ) (e.g., when one or more labels or regression values are provided for each token 905, and if f(x)=x). As an example, the model head 1034 may include at least one layer which calculates an average over all tokens 905. As another example, the model head 1034 may be a fully-connected head which leads to the last single neuron (e.g., Tₒᵤₜₚᵤₜ=1), or which applies a fully-connected head onto a single token 905 (e.g., a class token) when Toutput=Tinput+1.

According to embodiments, some of the examples of the prediction model 8331 discussed above may include self-attention blocks. Because such blocks may be permutation invariant by construction, they may be preceded with positional encoding, according to embodiments. For example, according to embodiments, the prediction model 8331 may use a rotary positional encoder (ROPE) to perform positional encoding before the self-attention blocks. According to embodiments, the series of commands included in the data stream 901 may include three variables that monotonously increase with a token index m: the token's cumulative volume vₘ, the average token time stamp tₘ, and the cumulative command number Nₘ. Therefore, a ROPE token index may be replaced by a function POS(vₘ, tₘ, Nₘ), where POS may denote a multi-layer-perceptron.

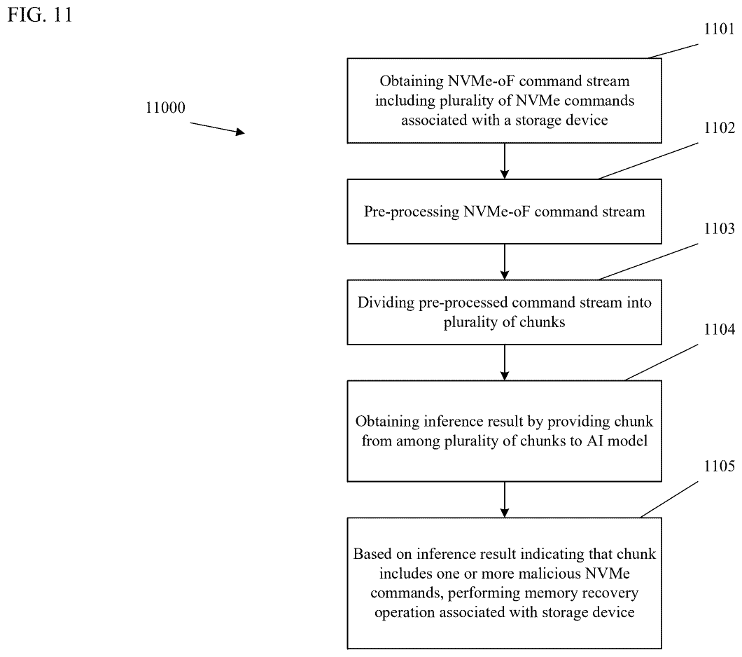

FIG. 11 is a flowchart of a process 11000 of controlling a storage device, according to embodiments. In some implementations, one or more process blocks of FIG. 11 may be performed by the ransomware defense module 8330 or any other element described above.

As shown in FIG. 11, at operation 1101 the process 11000 may include obtaining an NVMe-oF command stream including a plurality of NVMe commands associated with a storage device. In embodiments, the storage device may correspond to the SSD 8300, and the NVMe-oF command stream may correspond to the data stream 901 discussed above.

As further shown in FIG. 11, at operation 1102 the process 11000 may include pre-processing the NVMe-oF command stream to obtain a pre-processed command stream. In embodiments, the pre-processed command stream may correspond to the pre-processed data stream 902 discussed above.

As further shown in FIG. 11, at operation 1103 the process 11000 may include dividing the pre-processed command stream into a plurality of chunks. In embodiments, the plurality of chunks may correspond to the chunks 904 discussed above.

As further shown in FIG. 11, at operation 1104 the process 11000 may include obtaining an inference result by providing a chunk from among the plurality of chunks to an AI model. In embodiments, the AI model may correspond to the prediction model 8331, the inference result may correspond to the inference result 907 discussed above.

As further shown in FIG. 11, at operation 1105 the process 11000 may include, based on the inference result indicating that the chunk includes one or more malicious NVMe commands, performing a memory recovery operation associated with the storage device. In embodiments, the memory recovery operation may correspond to the recovery operation 909 discussed above.

In embodiments, the process 11000 may include dividing the chunk into a plurality of tokens,
and the inference result may be obtained by providing the plurality of tokens to the AI model. In embodiments, the plurality of tokens may correspond to the tokens 905 discussed above.

In embodiments, the AI model may include a fully-connected neural network, which may correspond to the prediction model 8331A discussed above. The obtaining the inference result may include: obtaining a feature vector that includes embedding features corresponding to the plurality of tokens; flattening the feature vector to obtain a flattened feature vector; and providing the flattened feature vector to the fully-connected neural network.

In embodiments, the AI model may include a CNN, which may be arranged according to a U-Net architecture that includes a plurality of encoder blocks and a plurality of decoder blocks, and which may correspond to the prediction model 8331B discussed above. In embodiments, each of the plurality of encoder blocks and the plurality of decoder blocks may include: a plurality of one-dimensional convolutional blocks having different filter sizes, a self-attention module preceded by an addition with a rotational positional encoding, and a ResNet block.

In embodiments, the AI model may include a transformer model, which may correspond to the prediction model 8331C discussed above.

In embodiments, the inference result may include at least one from among: a label corresponding to the chunk, wherein the label indicates a prediction about whether the chunk includes the one or more malicious NVMe commands, a plurality of labels corresponding to the chunk, wherein each label from among the plurality of labels corresponds to a token from among the plurality of tokens, a regression value for each token, wherein the regression value is within a range that indicates at least one from among a predicted number of the one or more malicious NVMe commands, and a predicted amount of data corresponding to the one or more malicious NVMe commands, and a plurality of regression values for each token, wherein each regression value from among the plurality of regression values corresponds to a type of the one or more malicious NVMe commands.

In embodiments, the detecting may be performed based on a plurality of inference results corresponding to the plurality of chunks.

In embodiments, each chunk from among the plurality of chunks may share at least one common attribute, and the at least one common attribute may include at least one from among an amount of time corresponding to each chunk, a number of commands corresponding to each chunk, and an amount of data corresponding to each chunk.

In embodiments, pre-processing the NVMe-oF command stream may include generating additional data about at least one attribute associated with each NVMe command included in the plurality of NVMe commands, and the pre-processed command stream may include the additional data.

Although FIG. 11 shows example blocks of process 11000, in some implementations, the process 11000 may include additional blocks, fewer blocks, different blocks, or differently arranged blocks than those depicted in FIG. 11. Additionally, or alternatively, two or more of the blocks of the process 11000 may be arranged or combined in any order, or performed in parallel.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

The various operations of methods described above may be performed by any suitable means capable of performing the operations, such as various hardware and/or software component(s), circuits, and/or module(s).

The software may include an ordered listing of executable instructions for implementing logical functions, and can be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The foregoing is illustrative of the embodiments and is not to be construed as limiting thereof. Although a few embodiments have been described, those skilled in the art will readily appreciate that many modifications are possible in the embodiments without materially departing from the present scope.

What is claimed is:

1. A method for performing ransomware detection, the method being executed by at least one processor and comprising:
obtaining a nonvolatile memory express over fabrics (NVMe-oF) command stream comprising a plurality of nonvolatile memory express (NVMe) commands associated with a storage device;
pre-processing the NVMe-oF command stream to obtain a pre-processed command stream;
dividing the pre-processed command stream into a plurality of chunks;
obtaining an inference result by providing a chunk from among the plurality of chunks to an artificial intelligence (AI) model; and
based on the inference result indicating that the chunk includes one or more malicious NVMe commands, performing a memory recovery operation associated with the storage device.

2. The method of claim 1, further comprising dividing the chunk into a plurality of tokens,
wherein the inference result is obtained by providing the plurality of tokens to the AI model.

3. The method of claim 2, wherein the AI model comprises a fully-connected neural network, and
wherein the obtaining the inference result comprises:
obtaining a feature vector comprising embedding features corresponding to the plurality of tokens;
flattening the feature vector to obtain a flattened feature vector; and
providing the flattened feature vector to the fully-connected neural network.

4. The method of claim 2, wherein the AI model comprises a convolutional neural network (CNN),
wherein the CNN is arranged according to a U-Net architecture comprising a plurality of encoder blocks and a plurality of decoder blocks, and
wherein each of the plurality of encoder blocks and the plurality of decoder blocks comprises:
a plurality of one-dimensional convolutional blocks having different filter sizes,
self-attention module preceded by an addition with a rotational positional encoding, and
a residual network (ResNet) block.

5. The method of claim 2, wherein the AI model comprises a transformer model.

6. The method of claim 2, wherein the inference result comprises at least one from among:
a label corresponding to the chunk, wherein the label indicates a prediction about whether the chunk includes the one or more malicious NVMe commands,
a plurality of labels corresponding to the chunk, wherein each label from among the plurality of labels corresponds to a token from among the plurality of tokens,
a regression value for each token, wherein the regression value is within a range that indicates at least one from among a predicted number of the one or more malicious NVMe commands, and a predicted amount of data corresponding to the one or more malicious NVMe commands,
a plurality of regression values for each token, wherein each regression value from among the plurality of regression values corresponds to a type of the one or more malicious NVMe commands.

7. The method of claim 1, wherein the detecting is performed based on a plurality of inference results corresponding to the plurality of chunks.

8. The method of claim 7, wherein each chunk from among the plurality of chunks share at least one common attribute, and
wherein the at least one common attribute comprises at least one from among an amount of time corresponding to each chunk, a number of commands corresponding to each chunk, and an amount of data corresponding to each chunk.

9. The method of claim 1, wherein the pre-processing the NVMe-oF command stream comprises generating additional data about at least one attribute associated with each NVMe command included in the plurality of NVMe commands, and
wherein the pre-processed command stream comprises the additional data.

10. A device for performing ransomware detection, the device comprising:
an interface configured to communicate with a storage device; and
at least one processor configured to:
obtain nonvolatile memory express over fabrics (NVMe-oF) command stream comprising a plurality of nonvolatile memory express (NVMe) commands associated with the storage device;
pre-process the NVMe-oF command stream to obtain a pre-processed command stream;
divide the pre-processed command stream into a plurality of chunks;
obtain an inference result by providing a chunk from among the plurality of chunks to an artificial intelligence (AI) model; and
based on the inference result indicating that the chunk includes one or more malicious NVMe commands, perform a memory recovery operation associated with the storage device.

11. The device of claim 10, wherein the at least one processor is further configured to divide the chunk into a plurality of tokens, and
wherein the inference result is obtained by providing the plurality of tokens to the AI model.

12. The device of claim 11, wherein the AI model comprises a fully-connected neural network, and
wherein the obtaining the inference result comprises:
obtaining a feature vector comprising embedding features corresponding to the plurality of tokens;
flattening the feature vector to obtain a flattened feature vector; and
providing the flattened feature vector to the fully-connected neural network.

13. The device of claim 11, wherein the AI model comprises a convolutional neural network (CNN),
wherein the CNN is arranged according to a U-Net architecture comprising a plurality of encoder blocks and a plurality of decoder blocks, and
wherein each of the plurality of encoder blocks and the plurality of decoder blocks comprises:
a plurality of one-dimensional convolutional blocks having different filter sizes,
self-attention module preceded by an addition with a rotational positional encoding, and
a residual network (ResNet) block.

14. The device of claim 11, wherein the AI model comprises a transformer model.

15. The device of claim 11, wherein the inference result comprises at least one from among:
a label corresponding to the chunk, wherein the label indicates a prediction about the presence of the one or more malicious NVMe commands,
a plurality of labels corresponding to the chunk, wherein each label from among the plurality of labels corresponds to a token from among the plurality of tokens,
a regression value for each token, wherein the regression value is within a range that indicates at least one from among a predicted number of the one or more malicious NVMe commands, and a predicted amount of data corresponding to the one or more malicious NVMe commands,
a plurality of regression values for each token, wherein each regression value from among the plurality of regression values corresponds to a type of the one or more malicious NVMe commands.

16. The device of claim 10, wherein the detecting is performed based on a plurality of inference results corresponding to the plurality of chunks.

17. The device of claim 16, wherein each chunk from among the plurality of chunks share at least one common attribute, and
wherein the at least one common attribute comprises at least one from among an amount of time corresponding to each chunk, a number of commands corresponding to each chunk, and an amount of data corresponding to each chunk.

18. The device of claim 10, wherein to pre-process the NVMe-oF command stream, the at least one processor is further configured to generate additional data about at least one attribute associated with each NVMe command included in the plurality of NVMe commands, and
wherein the pre-processed command stream comprises the additional data.

19. A storage system, comprising:
a storage device;
a ransomware detection device comprising at least one processor configured to:
obtain a nonvolatile memory express over fabrics (NVME-oF) command stream comprising a plurality of nonvolatile memory express (NVMe) commands associated with the storage device;
pre-process the NVMe-oF command stream to obtain a pre-processed command stream;
divide the pre-processed command stream into a plurality of chunks;
obtaining an inference result by providing a chunk from among the plurality of chunks to an artificial intelligence (AI) model; and
based on the inference result indicating that the chunk includes one or more malicious NVMe commands, perform a memory recovery operation associated with the storage device.

20. The system of claim 19, wherein the AI model comprises at least one from among a fully-connected neural network, a convolutional neural network (CNN) arranged according to a U-Net architecture, and a transformer model.
